(19) United States
(12) Patent Application Publication
(10) Pub. No.: US 2024/0281593 A1
(43) Pub. Date: Aug. 22, 2024

(54) METHOD AND SYSTEM FOR CONTENT DISTRIBUTION INCLUDING CONTENT RESTRUCTURING FOR INCREASED READABILITY

(71) Applicant: Microsoft Technology Licensing, LLC, Redmond, WA (US)

(72) Inventors: Graham KENT, Seattle, WA (US); Sara Thayer CUMMINGS, Seattle, WA (US); Roberta CANNEROZZI, Bellevue, WA (US); Jeremy Michael GRUBAUGH, Kirkland, WA (US)

(73) Assignee: Microsoft Technology Licensing, LLC, Redmond, WA (US)

(21) Appl. No.: 18/171,537

(22) Filed: Feb. 20, 2023

(51) Int. Cl. G06F 40/166; G06F 40/106; G06Q 50/00

(52) U.S. Cl. CPC G06F 40/166; G06F 40/106; G06Q 50/01

(57) ABSTRACT

A system and method for content distribution with enhanced readability includes a processor; a memory in communication with the processor, the memory comprising programming for execution by the processor; a network interface for connecting the system to a computer network; and a content distribution application to be executed from the memory by the processor. The content distribution application, when executed, causes the processor to: receive, from a client application, an original set of content assembled by a user to be posted through the content distribution application; submit the original set of content to an artificial intelligence trained to restructure the original set of content prior to distribution; return to the user a proposed post for display in the client application, the proposed post comprising information from the original set of content in a restructured form; receive, from the user via the client application, approval of, or further editing of, the proposed post; and post a finalized post based on approval of, or further editing of, the proposed post so as to distribute the information from the original set of content as restructured in the finalized post.

### BACKGROUND

With modern communications applications and technology, people can publish information to a potentially very wide audience. Ideas, opinions, news and other information can be posted on a vast array of sites to attract interested readers. On the social media sites and other sites of the Internet, this potential readership can be vast. Alternatively, within the context of a particular organization, such posts may convey important information among different organization members.

When information is presented in written form, there are a number of factors that govern the readability or digestibility of the information. Presenting ideas with a logical flow, choosing the most apt vocabulary, and emphasizing important concepts or points all contribute to how readable the writing is. Readability determines whether a reader is engaged and informed or confused by the writing.

The need to present written information in an interesting or highly readable form can be a challenge. Through experience or talent, some writers are able to craft highly readable text for a post or other publication. However, for other writers, it may be relatively straightforward to assemble the information that needs to be communicated, but a significant challenge to draft a written statement including that information that attracts attention and is highly readable to the intended audience. Such difficulties are compounded if the writer is trying to communicate in a non-native language.

Consequently, presenting assembled information in a highly readable written statement when the author is not adept at doing so is a technical problem. Thus, there is a need for improved systems and methods of assisting writers to present information in a readable written statement, such as a news post.

### SUMMARY

In one general aspect, the instant disclosure presents a content distribution system that includes: a processor; a memory in communication with the processor, the memory comprising programming for execution by the processor; a network interface for connecting the system to a computer network; and a content distribution application to be executed from the memory by the processor. The content distribution application, when executed, causes the processor to: receive, from a client application, an original set of content assembled by a user to be posted through the content distribution application; submit the original set of content to an artificial intelligence trained to restructure the original set of content prior to distribution; return to the user a proposed post for display in the client application, the proposed post comprising information from the original set of content in a restructured form; receive, from the user via the client application, approval of, or further editing of, the proposed post; and post a finalized post based on approval of, or further editing of, the proposed post so as to distribute the information from the original set of content as restructured in the finalized post.

In another general aspect, the instant disclosure presents a data processing system that includes: an artificial intelligence trained to restructure a set of content prior to distribution; a content distribution system comprising a processor and a memory in communication with the processor, the memory comprising programming for execution by the processor; a network interface of the content distribution system for communication with a client device; and a content distribution application to be executed from the memory by the processor, the content distribution application to cause the processor to: receive, from a client application on the client device, an original set of content assembled by a user to be posted through the content distribution system; submit the original set of content to the artificial intelligence; receive a proposed post from the artificial intelligence, the proposed post being the original set of content in a restructured form; return the proposed post to the user for display in the client application; receive, from the user via the client application, approval of, or further editing of, the proposed post; and post a finalized post based on approval of, or further editing of, the proposed post so as to distribute the information from the original set of content as restructured in the finalized post.

In a further general aspect, the instant application describes a method for restructuring content assembled by a user to produce a finalized post for publication through a content distribution system, the method comprising: receiving, from a user, an original set of content assembled by the user to be posted through the content distribution system; submitting the original set of content to an artificial intelligence (AI) tool trained to restructure the content prior to distribution; returning to the user a proposed post comprising content from the original set of content in a restructured form produced by the AI tool; receiving, from the user, approval of, or further editing of, the proposed post; and posting a finalized post based on user approval of, or further editing of, the proposed post so as to distribute the content from the original set of content as restructured in the finalized post.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example of some of the elements of a content distribution system upon which aspects of this disclosure may be implemented.

FIG. 3 depicts an illustrative interface for a client application with which aspects of this disclosure may be implemented.

FIGS. 3A, 3B and 3C further depict the interface of FIG. 3 in different stages of processing an original set of content or information for enhanced readability.

FIG. 4 is a flow diagram depicting an illustrative method for enhancing the readability of an original set of content or information.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

As noted above, the need to present written information in an interesting or readable form can be a challenge. Through experience or talent, some writers are able to craft highly readable text for a post or other publication. However, for other writers, it may be straightforward to assemble the information that needs to be communicated, but a significant challenge to draft a written statement that attracts attention and is highly readable to the intended audience. Such difficulties are compounded if the writer is trying to communicate in a non-native language.

Consequently, presenting a collection of information in a highly readable written statement when the author is not adept at doing so is a technical problem that can have a variety of technical solutions. To address such technical problems that exist in producing text with high readability, the present specification describes systems and methods that apply technology to restructure information or content collected by a user into a different form with enhanced readability. In particular, the technical solutions described herein may focus on elements such as intelligently generating an apt title, effective summary and listing of main points as part of the restructuring of content into a more readable form More specifically, to address the indicated technical problems and more, in an example, this description provides technical solutions for intelligently restructuring an input set of textual content or information using artificial intelligence. The artificial intelligence used may include an artificial intelligence tool, for example, a Generative Pre-trained Transformer (GPT). A current example of a GPT is GPT-3.

A GPT, in general, and GPT-3 specifically, is an autoregressive language model that uses deep learning to produce text in a form similar to what might have been produced by a human being. Specifically, GPT-3 includes a neural network machine learning model that has been trained using the vast quantity of written materials available on the internet to generate any requested type of text. Trained in this way, the system becomes a language prediction model. In a simple example, given an initial text as prompt, GPT-3 can produce text that continues the prompt. In more complex examples, GPT-3 uses its neural network machine learning model to ingest an original text as the input and then transforms and/or expands the text into a document that the model predicts will be most useful based on its vast training corpus. The deep learning neural network of GPT-3 is a model with over 175 billion machine learning parameters, representing a 17 fold increase over prior GPT models.

GPT-3, earlier GPT models and subsequent GPT models can be used to implement the systems and methods described herein. Additionally, other forms of artificial intelligence or machine learning may be used. Such an artificial intelligence can be trained on a large corpus of existing text, as described below, so as to output a restructured text with improved readability.

Consequently, as will be understood by persons of skill in the art upon reading this disclosure, benefits and advantages provided by such implementations can include, but are not limited to, a technical solution to the technical problems of lack of mechanisms for efficiently and conveniently enhancing the readability of a text. The technical solutions enable automatic generation of a restructured text, for example a post to be published through a content distribution system. This not only eliminates or reduces the need for human editing time, but may provide results with readability enhanced beyond what the user would achieve. The technical effects include, at least, (1) improving the readability of a content being shared by a user; (2) improving the efficiency of a user's written communications; and (3) improving the searchability of posted text by associating into the text more accurate titles, summaries and main points.

As used herein, the term “content distribution application” or content distribution service will refer to a communications application that makes use of a computer network to distribute content including both written and graphical content. Typically, a content distribution application, as used herein, executes on a networked server to receive and distribute content to any number of client or subscriber devices/applications. Examples may include social media sites, enterprise or organization news sites, SharePoint®, and other content distribution applications. The term “content distribution system” will refer to a server or other computer that executes a content distribution application with connections to a computer or data network over which the content is distributed or published to users.

As used herein, the term “client application” refers to the application on a client or user device that interfaces with and provides access to a content distribution application or system. In some examples, the content distribution application is accessed from a client device through a browser. In such a case, the browser serves as the client application. In other examples, a specific agent application corresponding to the content distribution application may be installed on the client or user device and is dedicated to providing access to the content distribution application. In such cases the local agent application is the client application, as that term is used herein. For example, a SharePoint® client application may be installed on an individual computer and then used to access a SharePoint® site, i.e., a content distribution application, for a corresponding enterprise.

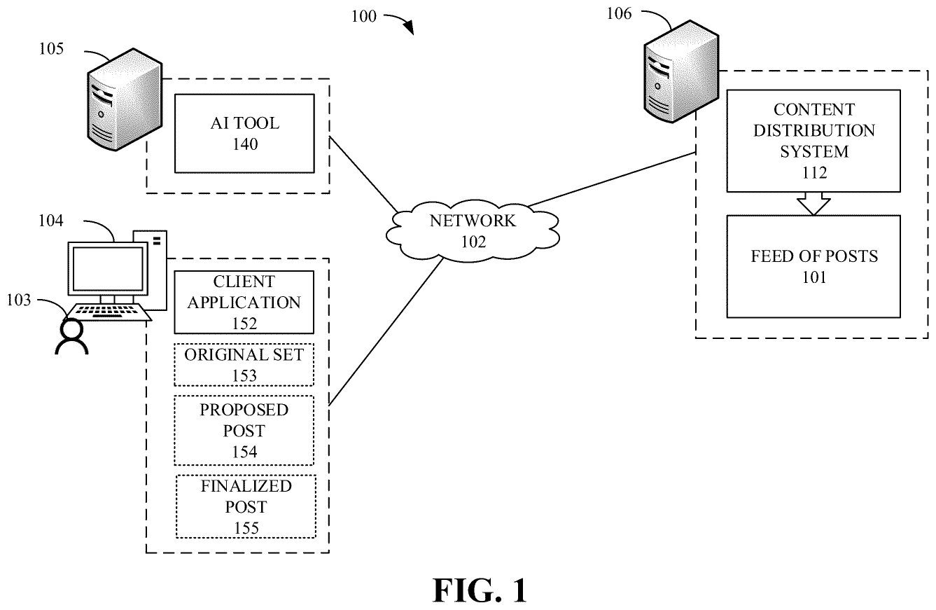

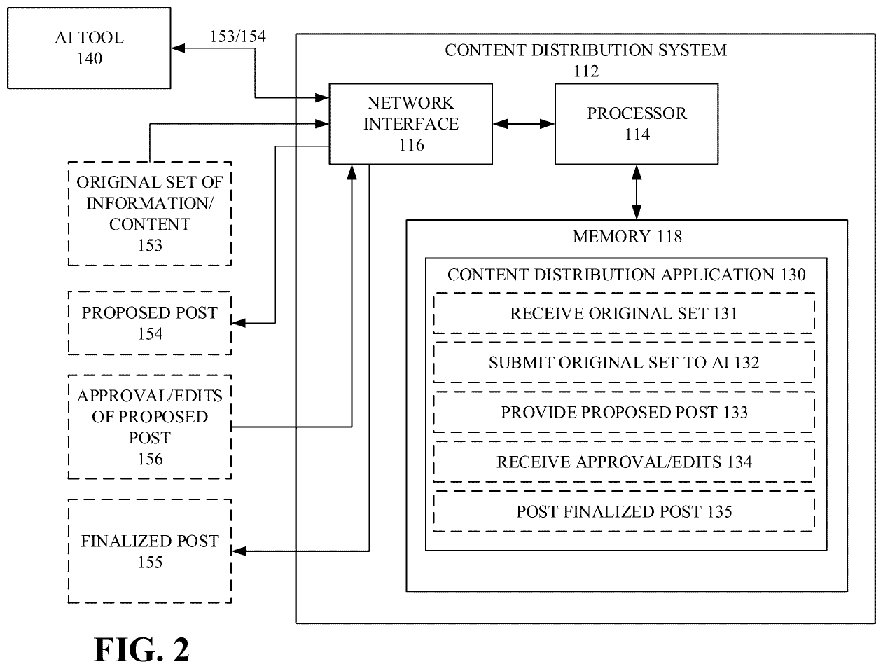

FIG. 1 illustrates an example system 100, upon which aspects of this disclosure may be implemented. The system 100 includes a server 106, which provides a content distribution system 112 through a computer or data network 102. As described herein, the content distribution system 112 includes a content distribution application executing on the server 106. (See FIG. 2). In the example of FIG. 1, the content distribution system 112 produces a feed of posts 101. Each post includes content submitted by a user 103 of the content distribution system 112 that is published for receipt by other users of the content distribution system 112 via the feed 101.

While shown as one server, the server 106 may represent a plurality of servers that work together to deliver the functions and services of the content distribution system 112. The server 106 may operate as a cloud-based server for distributing content, including the feature of restructuring submitted content for increased readability prior to posting. The server 106 may also operate as a shared resource server located at an enterprise accessible by various computer client devices such as a client device 104. The client device 104 may be any computerized device such as, but not limited to, a laptop, personal computer, mobile phone, tablet computer, personal digital assistant and others.

By way of example, an illustrative operation of the system 100 will now be described. To begin the example, a human user 103 operating the client device 104 desires to distribute content that he or she has assembled. Accordingly, using the client device 104, the user assembles the content, referred to herein as the original set of content 153. This content will include: (1) elements originally written or designed by the user 103, (2) elements taken, such as by cutting and pasting, from another or disparate sources or (3) a combination of both.

The user assembles and organizes the content in any form desired using the applications and the tools available on the client device. For example, a word processor, slide manager, browser, spreadsheet, computer-aided design application or any other such application may be used by the user to access, create, organize or assemble the content or elements of the content that will comprise the original content set 153.

Once assembled, the original set of content 153 is sent via the client application 152 to the content distribution system 112 for publication. For example, the client device 104 may communicate via the computer network 102 with the server 106, which is remote from the client device and that is hosting the content distribution system 112. As defined above, the client application 152 may be, for example, a browser. Alternatively, the client application 152 may be a specific agent application that is installed on the client or user device 104 and that is dedicated to providing access to a content distribution application of the content distribution system 112.

As described above, there may be a need to restructure the original set of content 153 to improve readability. For example, if the user 103 does not have time to carefully structure the content 153 for readability, is not skilled at doing so or is, perhaps writing in a non-native language, the original set of content 153 may have a low readability. As a result, if published or posted in its original form, the original set of content 153 will not be an effective communication. It may be overlooked, ignored, or poorly understood by other users of the content distribution system with whom the user 103 wants to communicate. This is a technical problem for which the content distribution system provides a technical solution.

As will be described in further detail below, the content distribution system 112 will have access to an Artificial Intelligence (AI) tool that has been trained, as described above, to restructure the original set of content 153 for improved readability. This AI tool 140 may be incorporated into the content distribution system 112 and reside at the same location. Alternatively, the AI tool 140 may be provided by a separate server 105 or other computer system at a remote location. In either case, the content distribution system 112 submits the original set of content 153 to the AI tool 140.

As will be further described below, the AI tool 140 will ingest the original set of content 153 and restructure the content. This may include, in some examples, any of reorganizing, rewording, and expanding the original set of content. This may include, in some examples, adding additional related or relevant content. In still other examples, the AI tool 140 generates from the original set of content 153, a new or revised title, a new or revised summary and a new or revised listing of main points as part of restructuring the content. A Machine Learning Model may be used in ranking the main points or other feed content. Specifically, a Machine Learning Model can be trained on various input to recognize, for example, based on repetition of a particular point in the content, which are the main points and rank them accordingly. Thus, within the AI tool, one or more Machine Learning Models may be used to rank the main points or other content when restructuring the content submitted by the user. Machine Learning Models may be used for other tasks within the restructuring of the user-submitted content.

The result is referred to as a proposed post 154 that is produced by the AI tool 140 and subsequently delivered by the content distribution system 112 to the client device 104 and displayed for the user through the client application 152. The user 103 can then review the proposed post 154 before anything is published by the content distribution system 112.

The user 103 can also edit the proposed post 154. For example, the user may wish to change the wording in some parts of the proposed post 154. The user may wish to remove or reverse changes made to the original content set 153 in the proposed post. The user may also wish to expand on something included in the proposed post 154. For example, the AI tool 140 may have added recognition of other users, thanking them in connection with the post. The user 103 may remember that an additional person should be added to this recognition and edit the proposed post 154 accordingly.

The client application 152 may include all the tools used for editing or approving of the proposed post. For example, the client application may include a text editing function, a graphics editing function and tools for rearranging, cutting and pasting and deleting elements of the proposed post.

Thus, the user 103 retains complete control over what content is ultimately published, but has the benefit of the AI tool 140 to assist in restructuring the original set of content 153 for improved readability. The result of any further editing by the user on the proposed post 154 is then referred to as the finalized post 155. The finalized post 155 now provides more effective communication of the information from the original set of content 153, given the technical solution implemented as described in FIG. 1.

The finalized post 155 is then sent by the client application 152, via the network 102, to the content distribution system 112. The finalized post 155 is then published in the feed of posts 101 by the content distribution system 112. The feed of posts 101 will be accessible via the network 102 and client applications of the audience of users who are subscribed to the content distribution system 112.

It should be understood that the system 100 depicted in FIG. 1 is provided by way of example and the system 100 and/or further systems contemplated by this present disclosure may include additional and/or fewer components, may combine components and/or divide one or more of the components into additional components, etc. For example, the system 100 may include any number of servers 106/105, client devices 104, or networks 102.

FIG. 2 depicts additional details of the content distribution system 112 discussed above and illustrated in FIG. 1. As shown in FIG. 2, the content distribution system 112 may be implemented in a server or other computer system that includes a processor 114, memory 118 and network interface 116. The network interface 116 connects the system 112 and processor 114 with a computer network, such as the internet, a Local Area Network (LAN), a Wide Area Network (WAN), a wireless network, combinations of these or any other computer or data network so as to accomplish the functionality described.

The processor 114 may include, for example, a central processing unit (CPU), a graphics processing unit (GPU), a digital signal processor (DSP), an ASIC, or a suitable combination thereof. The processor 114 may also include one or more processors that may execute programming, such as the instructions 131-135, and process data. In some examples, one or more processors may execute instructions provided or identified by one or more other processors. The term “processor” includes a multi-core processor including cores that may execute instructions contemporaneously. The system 112 may include a single processor with a single core, a single processor with multiple cores (for example, a multi-core processor), multiple processors each with a single core, multiple processors each with multiple cores, or any combination thereof. In some examples, the system 112 may include multiple processors distributed among multiple machines.

The memory 118 may include nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The nonvolatile memory component of the memory 118 stores the content distribution application 130, as discussed above, which is executed by the processor 114 to implement the functionality of the content distribution system 112.

Relative to the feature of providing content restructuring to enhance readability, the content distribution application 130 includes instructions or code modules to perform each of the following functions. As shown in FIG. 2 and as described above with reference to FIG. 1, these code modules include programing (1) to receive the original set of content 131; (2) to submit the original set of content to the AI 132; (3) to, upon receipt of the proposed post generated by the AI, provide the proposed post to the corresponding client application/user 133; (4) to receive user approval or edits to the proposed post constituting a finalized post 134; and (5) to post the finalized post 135, for example, in the feed described above in connection with FIG. 1.

As shown in FIG. 2, the network interface 116 allows the processor 114 to receive the original set of content 153. If the AI for restructuring the content is located remote from the content distribution system 112, the network interface 116 further allows the processor 114 to submit the original set of content 153 to the AI tool 140 and to receive a restructured version of the content from the AI tool 140. This restructured version is again referred to as a proposed post 154.

The processor 114 executing the content distribution application 130 again uses the network interface 116 to provide the proposed post 154 to the user via the client application, as described above. The network interface 116 then receives the approval of or edits to the proposed post 156 from the user and submits the data to the processor 114 executing the content distribution application 130. As noted, the user may simply accept and approve of the proposed post for publication. In such a case, the proposed post 154 becomes the finalized post 155. Alternatively, the user may edit the proposed post 154 and submit the result as constituting a finalized post 155.

The content distribution application 130 then uses the network interface 116 to output the finalized post 155 to a number of users via, for example, a post feed. Alternatively, the content distribution application 130 could address the finalized post to specific recipients, for example, via instant messaging, email or the like.

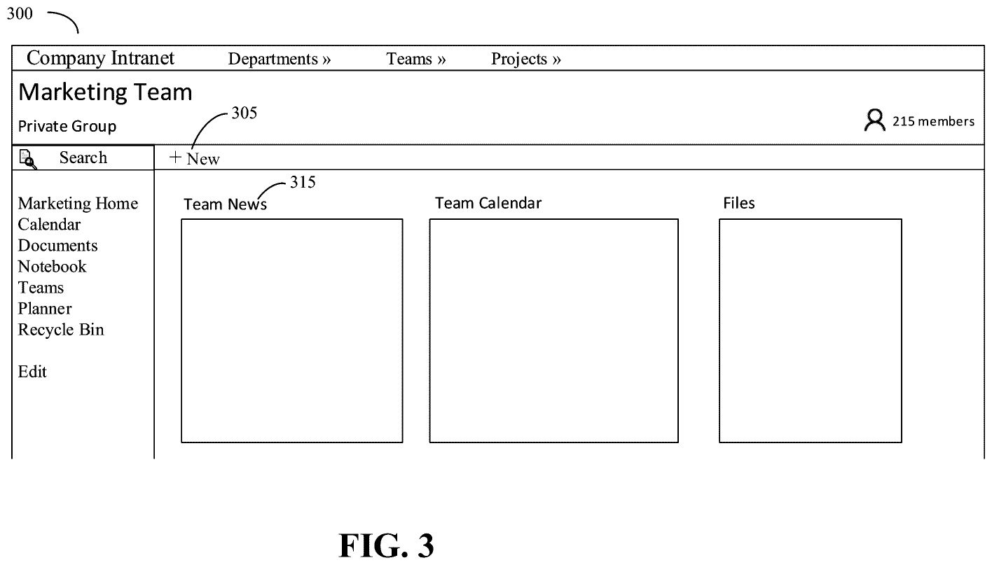

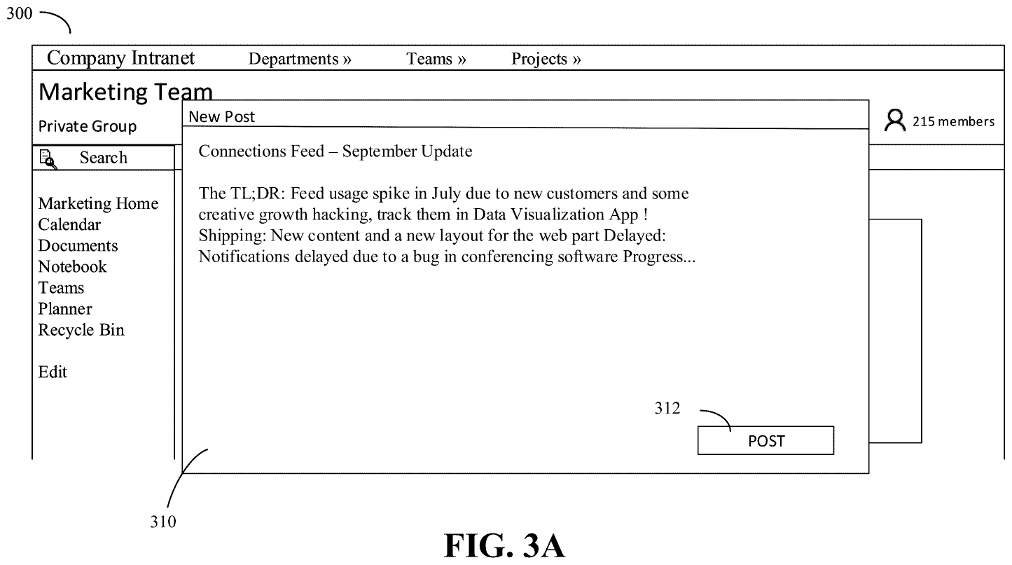

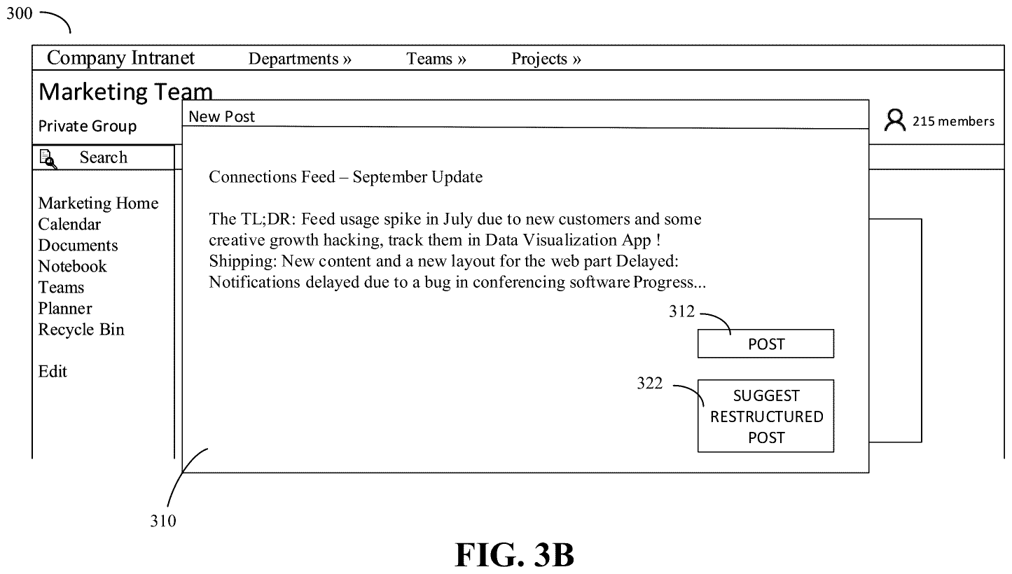

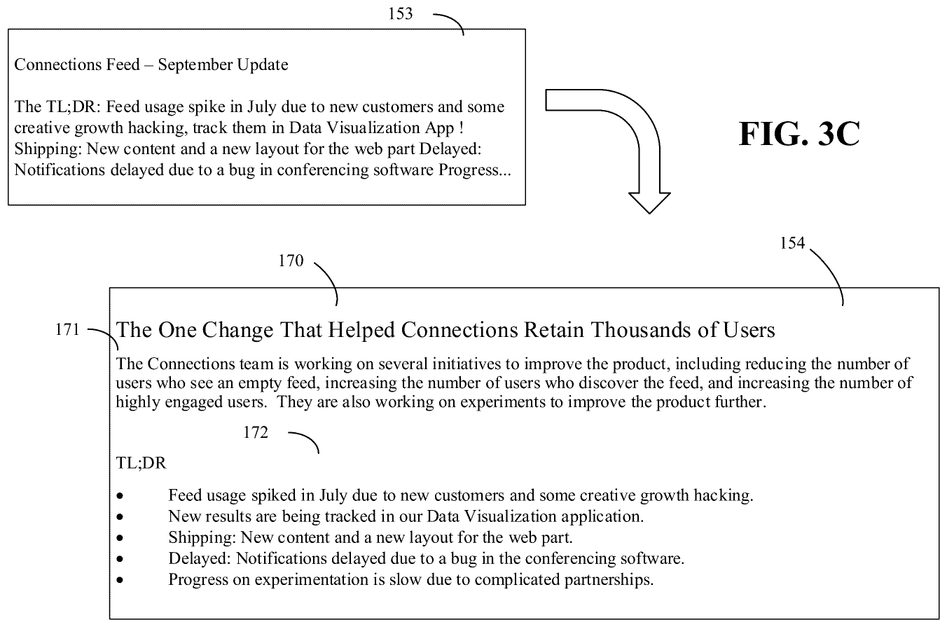

FIG. 3 depicts an illustrative interface for a client application with which aspects of this disclosure may be implemented. Specifically, FIG. 3 depicts an interface as seen in a client application 152 executing on a client or user device 104. As described above, the client application interacts with a remote content distribution application to provide the user with a means to both post new content and receive the content posted by other users to the system. Thus, this interface shown in FIG. 3 is an extension of the content distribution application that is being accessed through the client application.

In the example of FIG. 3, the user interface 300 of the client application may be a browser or a dedicated agent or client application. In either case, the interface 300 in this example is in communication with a content distribution system for a particular enterprise and is pointed at a page for the “Marketing Team” hosted on a company intranet. This page provides a post feed, labeled as “Team News,” as well as a “Team Calendar” and a listing of “Files” used by the team. With access to this system, a member of the team can receive news or other information via the Team News post feed. The team member can also access important events or deadlines on the Team Calendar. The team member can also share or access files needed by multiple team members.

In the current example, a team member desires to post a new content item to the Team News feed 315. Accordingly, the user selects the “New” button 305. This will cause the interface 300 to provide a window in which the user can enter an original set of content intended for a post to the Team News feed.

FIG. 3A depicts the new window 310 superimposed over the user interface 300 as shown in FIG. 3. As shown in FIG. 3A, the user has entered an original set of content to be posted. The original set of content illustrated in FIG. 3A is merely illustrative and without particular significance. As noted above, this content may include (1) elements originally written or designed by the user 103, (2) elements taken, such as by cutting and pasting, from another source or disparate sources or (3) a combination of both. The new window further includes a button 312 marked “POST.” Upon selection of this button, the content, as prepared by the user, may be posted to the post feed, e.g., the “Team News” feed of the content distribution system.

Alternatively, the system described herein for increasing the readability of the post may be engaged. As depicted in FIG. 3B, the window 310 in which the user is able to assemble content for a post may also include a button marked “SUGGEST RESTRUCTURED POST” 322. This button may be included as soon as the window 310 is opened in response to the user selecting the “New” button 305 to initiate a new post. In this case, the user can finish assembling the content and then can choose to either post the content in its current form, by selecting the “POST” button 312 or can request that the system offer a revised post with enhanced readability by selecting the “SUGGEST RESTRUCTURED POST” button 322.

Alternatively, the button 322 for “SUGGEST RESTRUCTURED POST” may not be presented initially. Rather, when the user selects the “POST” button 312, the system may then, in response, display the “SUGGEST RESTRUCTURED POST” button 322 for possible selection by the user. This may emphasis for the user the option to have the system offer a revised post with enhanced readability prior to posting the content.

FIG. 3C depicts an example of the operation of the AI tool 140. As shown in FIG. 3C, the user has assembled the original set of content 153. The user may write some or all of this content, may cut and paste in some or all of this content or otherwise assemble the content 153. The content 153 may include text and/or graphical elements.

When the user invokes the option for the system to suggest a restructured or revised version of the content, the AI tool 140, as described herein, processes the original content 153 to produce a proposed post 154. The proposed post 154, in this example, includes a title 170. The title is chosen to capture the essence of the original content 153 to alert a reader to the subject being addressed. This may spark interest for the reader and enhances the readability of the proposed post 154.

The proposed post 154 in this example will also include a summary 171, sometimes referred to as an executive summary. The summary 171 will briefly capture the scope of the original content without necessarily including all the detail of the original content. Again, this helps a reader to digest the information and improves the readability of the proposed post 154.

Lastly, the proposed post 154 in this example will include a list of main points 172 from the original content. This helps a reader understand what should be appreciated as significant in the original content and improves the readability of the proposed post 154. This list is sometimes referred to as the TL; DR or the “Too Long; Didn't Read” points of the content.

In some examples, there may be multiple ML models used to restructure the text. For example, there may be a title model that ingests the set of original content and produces a proposed title for the content as part of the proposed post 154. This model would be specifically trained with various sets of content for which an apt title is specified until the model can produce an apt title for a new content set. Similarly, there may be a summary model that is likewise trained to ingest the original set of content from the user and produce a summary of the content. There may also be a main points model that ingests the original set of content and produces a listing of main points from the content.

FIG. 3C illustrates only one possible example of the transition from original content to proposed post and the elements of the proposed post. In other examples, the proposed post can include more or fewer elements than a title, summary and list of main points. In any such example, the readability of the content is significantly enhanced as between the original content assembly and the proposed post. With the proposed post, the import and information of the original content is much more readily appreciable to a reader. The operation of the described system thus provides a technical means to improve the efficiency of communication for the author of the original content.

Additionally, as described herein the user remains in control of the eventual post. Specifically, the use can fully edit the proposed post with the usual editing tools. The user can ensure that the main points are, in fact, those points the user wishes to emphasize. The user can reorder the main points, if desired. The user can also amend the title or summary, as the user prefers.

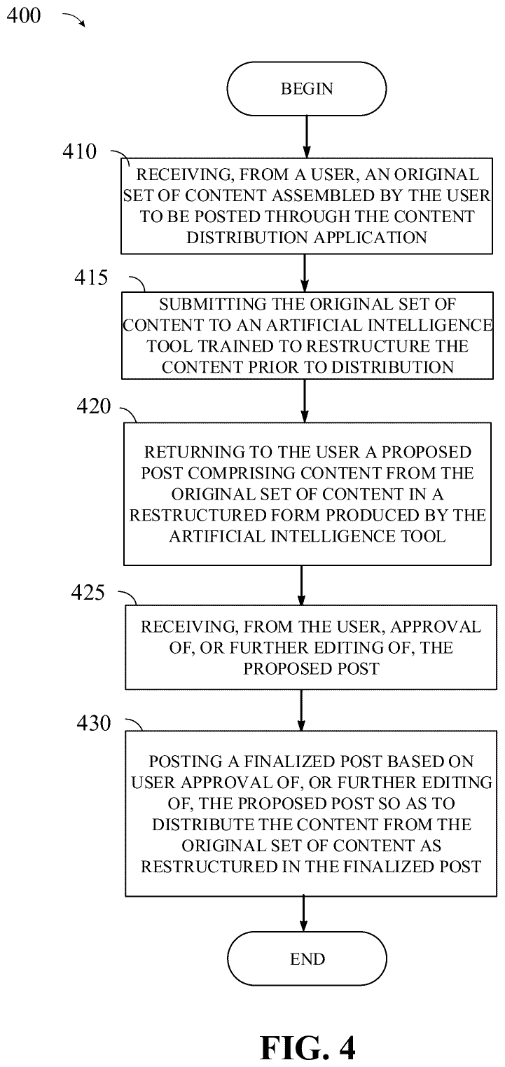

FIG. 4 depicts a flowchart 400 of the method and system operation described herein for increasing the readability of content being communicated. The flow begins with receiving 410, from a user, an original set of content assembled by the user to be posted through the content distribution application. As explained herein, the user assembles the original content to begin the operation.

Next, the flow continues with submitting 415 the original set of content to an artificial intelligence tool trained to restructure the content prior to distribution. This may be done only when authorized or instructed by the user to offer a proposed revision of the content. Alternatively, the system could use the AI tool to restructure the content for every post being made without authorization or instruction from the user prior to offering restructured content.

The flow continues with returning 420 to the user a proposed post comprising content from the original set of content in a restructured form produced by the AI tool. However, the user retains control to accept or revise the restructured content prior to posting. Thus, the flow continues with receiving 425, from the user, approval of, or further editing of, the proposed post.

The user input in 425 defines a finalized post. The flow concludes with posting 430 the finalized post based on user approval of, or further editing of, the proposed post so as to distribute the content from the original set of content as restructured in the finalized post. The readability of the finalized post will be increased as compared to the original content as described herein.

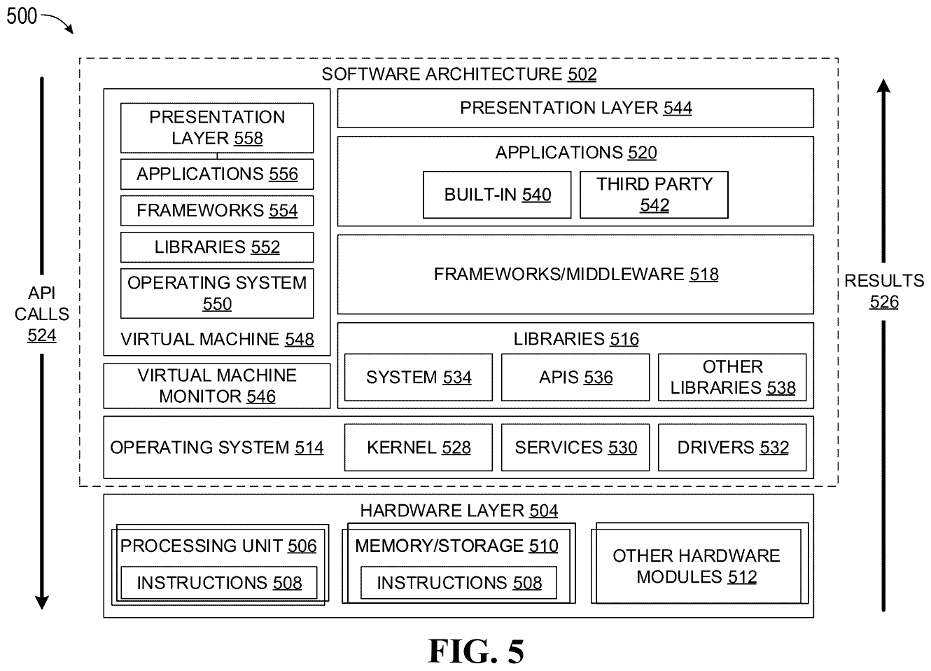

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

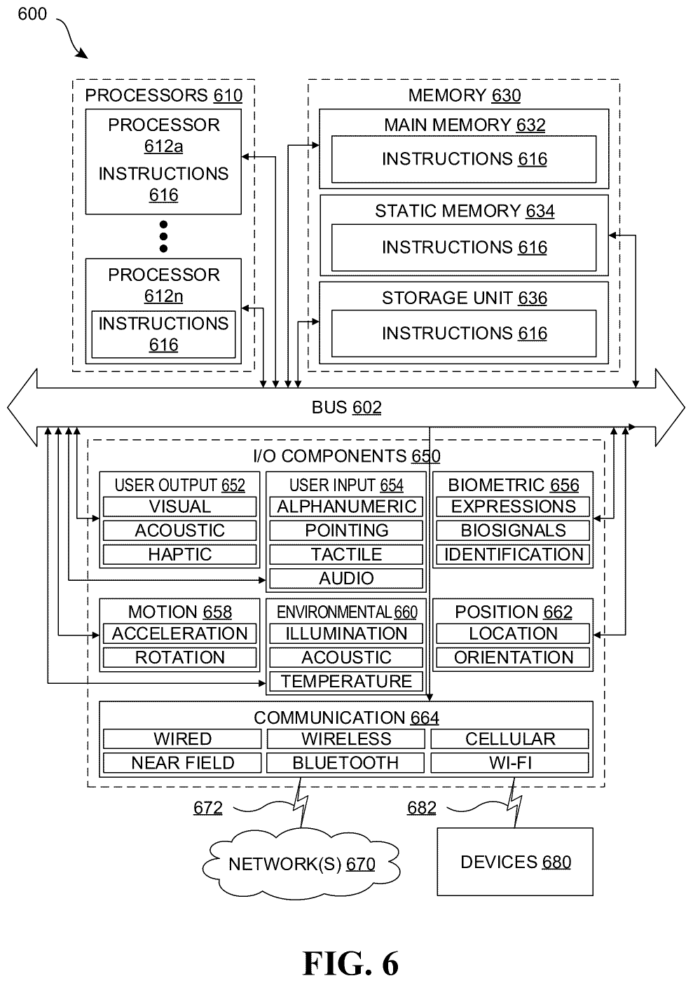

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A content distribution system comprising:
   a processor;
   a memory in communication with the processor, the memory comprising programming for execution by the processor;
   a network interface for connecting the system to a computer network; and
   a content distribution application to be executed from the memory by the processor, the content distribution application to cause the processor to:
   receive, from a client application, an original set of content assembled by a user to be posted through the content distribution application;
   submit the original set of content to an artificial intelligence (AI) trained to restructure the original set of content prior to distribution;
   return to the user a proposed post for display in the client application, the proposed post comprising information from the original set of content in a restructured form;
   receive, from the user via the client application, approval of, or further editing of, the proposed post; and
   post a finalized post based on approval of, or further editing of, the proposed post so as to distribute the information from the original set of content as restructured in the finalized post.
Item 2. The content distribution system of Item 1, wherein the proposed post comprises at least a title and a summary of the original set of content.
Item 3. The content distribution system of Item 1, wherein the proposed post comprises at least a title, a summary of the original set of content and a list of main points from the original set of content.
Item 4. The content distribution system of Item 1, wherein the processor outputs a feed of posts submitted by a number of users, the finalized post being added to the feed.
Item 5. The content distribution system of Item 1, further comprising a user interface, wherein the user interface, in response to receipt of an instruction to post the original set of content, offers an option to the user via the client application to generate the proposed post and, in response to an affirmative response to the option, submits the original set of content to the AI.
Item 6. The content distribution system of Item 1, further comprising a user interface of the client application in which the user operating the client application has tools to edit the proposed post including adding additional content to the proposed post to produce the finalized post.
Item 7. The content distribution system of Item 1, wherein the AI comprises a Generative Pretrained Transformer (GPT).
Item 8. A data processing system comprising:
   an artificial intelligence trained to restructure a set of content prior to distribution;
   a content distribution system comprising a processor and a memory in communication with the processor, the memory comprising programming for execution by the processor;
   a network interface of the content distribution system for communication with a client device; and
   a content distribution application to be executed from the memory by the processor, the content distribution application to cause the processor to:
   receive, from a client application on the client device, an original set of content assembled by a user to be posted through the content distribution system;
   submit the original set of content to the artificial intelligence;
   receive a proposed post from the artificial intelligence, the proposed post being the original set of content in a restructured form;
   return the proposed post to the user for display in the client application;
   receive, from the user via the client application, approval of, or further editing of, the proposed post; and
   post a finalized post based on approval of, or further editing of, the proposed post so as to distribute information from the original set of content as restructured in the finalized post.
Item 9. The data processing system of Item 8, wherein the proposed post comprises at least a title and a summary of the original set of content.
Item 10. The data processing system of Item 8, wherein the proposed post comprises at least a title, a summary of the original set of content and a list of main points from the original set of content.
Item 11. The data processing system of Item 8, wherein the processor outputs a feed of posts submitted by a number of users, the finalized post being added to the feed.
Item 12. The data processing system of Item 8, further comprising a user interface, wherein the user interface, in response to receipt of an instruction to post the original set of content, offers an option to the user via the client application to generate the proposed post and, in response to an affirmative response to the option, submits the original set of content to the artificial intelligence.
Item 13. The data processing system of Item 8, wherein the artificial intelligence comprises a Generative Pretrained Transformer (GPT).
Item 14. A method for restructuring content assembled by a user to produce a finalized post for publication through a content distribution system, the method comprising:
   receiving, from a user, an original set of content assembled by the user to be posted through the content distribution system;
   submitting the original set of content to an artificial intelligence (AI) tool trained to restructure the content prior to distribution;
   returning to the user a proposed post comprising content from the original set of content in a restructured form produced by the AI tool;
   receiving, from the user, approval of, or further editing of, the proposed post; and
   posting a finalized post based on user approval of, or further editing of, the proposed post so as to distribute the content from the original set of content as restructured in the finalized post.
Item 15. The method of Item 14, wherein the proposed post comprises at least a title and a summary of the original set of content.
Item 16. The method of Item 14, wherein the proposed post comprises at least a title, a summary and a list of main points from the original set of content.
Item 17. The method of Item 14, further comprising adding the finalized post to a feed of posts produced by the content distribution system.
Item 18. The method of Item 14, further comprising, in a user interface on a client device operated by the user, and in response to receipt from the user of an instruction via the user interface to post the original set of content, offering an option to generate the proposed post and, in response to an affirmative response to the option, submitting the original set of content to the AI tool.
Item 19. The method of Item 18, further comprising allowing a user operating the client device to edit the proposed post including adding additional content to the proposed post to produce the finalized post.
Item 20. The method of Item 14, wherein the AI tool comprises a Generative Pretrained Transformer (GPT).

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A content distribution system comprising:
a processor;
a memory in communication with the processor, the memory comprising programming for execution by the processor;
a network interface for connecting the system to a computer network; and
a content distribution application to be executed from the memory by the processor, the content distribution application to cause the processor to:
receive, from a client application, an original set of content assembled and structured by a user to be posted through the content distribution application;
submit the original set of content to an artificial intelligence (AI) trained to restructure the original set of content prior to distribution, wherein a prompt submitted to the AI with the original set of content instructs the AI to restructure the original set of content for increased readability by performing at least one of rewording, reorganizing or expanding the original set of content;
return to the user a proposed post for display in the client application, the proposed post comprising information from the original set of content in a restructured form;
receive, from the user via the client application, approval of, or further editing of, the proposed post; and
post a finalized post in the content distribution system as a post of the user placed in a feed of posts belonging to others so as to distribute the information from the original set of content as restructured in the finalized post, the finalized post being based on approval of, or further editing of, the proposed post.

2. The content distribution system of claim 1, wherein the proposed post comprises at least a title and a summary of the original set of content.

3. The content distribution system of claim 1, wherein the prompt directs the AI to restructure the original content to produce the proposed post comprising at least a title, a summary of the original set of content and a list of main points from the original set of content.

4. The content distribution system of claim 1, wherein the processor outputs a feed of posts submitted by a number of users, the finalized post being added to the feed.

5. The content distribution system of claim 1, further comprising a user interface, wherein the user interface, in response to receipt of an instruction to post the original set of content, offers an option to the user via the client application to generate the proposed post and, in response to an affirmative response to the option, submits the original set of content to the AI.

6. The content distribution system of claim 1, further comprising a user interface of the client application in which the user operating the client application has tools to edit the proposed post including adding additional content to the proposed post to produce the finalized post.

7. The content distribution system of claim 1, wherein the AI comprises a Generative Pretrained Transformer (GPT).

8. A data processing system comprising:
an artificial intelligence trained to restructure a set of content prior to distribution;
a content distribution system comprising a processor and a memory in communication with the processor, the memory comprising programming for execution by the processor;
a network interface of the content distribution system for communication with a client device; and
a content distribution application to be executed from the memory by the processor, the content distribution application to cause the processor to:
receive, from a client application on the client device, an original set of content that has been assembled and designed by a user to be posted through the content distribution system;
submit the original set of content to the artificial intelligence, wherein the artificial intelligence has been trained to restructure the original set of content for improved readability, the restructuring including any combination of rewording, reorganizing, summarizing and expanding the original set of content for increased readability;
receive a proposed post from the artificial intelligence, the proposed post being the original set of content in a restructured form;
return the proposed post to the user for display in the client application;
receive, from the user via the client application, approval of, or further editing of, the proposed post; and
post a finalized post in the content distribution system as a post of the user placed in a feed of posts belonging to others so as to distribute information from the original set of content as restructured in the finalized post, the finalized post being based on approval of, or further editing of, the proposed post.

9. The data processing system of claim 8, wherein the proposed post comprises at least a title and a summary of the original set of content.

10. The data processing system of claim 8, wherein a prompt submitted to the artificial intelligence with the original set of content directs the artificial intelligence to restructure the original set of content to produce the proposed post including at least a title, a summary of the original set of content and a list of main points from the original set of content.

11. The data processing system of claim 8, wherein the processor outputs a feed of posts submitted by a number of users, the finalized post being added to the feed.

12. The data processing system of claim 8, further comprising a user interface, wherein the user interface, in response to receipt of an instruction to post the original set of content, offers an option to the user via the client application to generate the proposed post and, in response to an affirmative response to the option, submits the original set of content to the artificial intelligence.

13. The data processing system of claim 8, wherein the artificial intelligence comprises a Generative Pretrained Transformer (GPT).

14. A method for restructuring content assembled by a user to produce a finalized post for publication through a content distribution system, the method comprising:
receiving, from a user, an original set of content assembled and designed by the user to be posted through the content distribution system as a post by the user to other users of the content distribution system;
submitting the original set of content to an artificial intelligence (AI) tool trained to restructure the content prior to distribution, wherein a prompt submitted to the AI with the original set of content instructs the AI to restructure the original set of content for increased readability by performing at least one of rewording, reorganizing or expanding the original set of content;
returning to the user a proposed post comprising content from the original set of content in a restructured form produced by the AI tool;
receiving, from the user, approval of, or further editing of, the proposed post; and
posting a finalized post in the content distribution system as a post of the user placed in a feed of posts belonging to others so as to distribute the content from the original set of content as restructured in the finalized post, the finalized post being based on approval of, or further editing of, the proposed post.

15. The method of claim 14, wherein the proposed post comprises at least a title and a summary of the original set of content.

16. The method of claim 14, wherein the proposed post comprises at least a title, a summary and a list of main points from the original set of content.

17. The method of claim 14, further comprising adding the finalized post to a feed of posts produced by the content distribution system.

18. The method of claim 14, further comprising, in a user interface on a client device operated by the user, and in response to receipt from the user of an instruction via the user interface to post the original set of content, offering an option to generate the proposed post and, in response to an affirmative response to the option, submitting the original set of content to the AI tool.

19. The method of claim 18, further comprising allowing a user operating the client device to edit the proposed post including adding additional content to the proposed post to produce the finalized post.

20. The method of claim 14, wherein the AI tool comprises a Generative Pretrained Transformer (GPT).
